(19) United States
(12) Patent Application Publication
(10) Pub. No.: US 2013/0075115 A1
(43) Pub. Date: Mar. 28, 2013

(54) Flame Suppression Agent, System and Uses

(71) Applicant: Clyde F. Parrish, Trinity, FL (US)

(72) Inventor: Clyde F. Parrish, Trinity, FL (US)

(73) Assignees: Space Administration, Washington, DC (US); United States of America as Represented by the Administrator of the National Aeronautics and

(21) Appl. No.: 13/428,736

(22) Filed: Mar. 23, 2012

Related U.S. Application Data
(63) Continuation-in-part of application No. 10/476,175, filed on Nov. 4, 2003.
(60) Provisional application No. 60/293,918, filed on May 25, 2001.

(51) Int. Cl. A62D 1/00; A62C 2/00

(52) U.S. Cl. CPC A62D 1/0028; A62C 2/00
USPC 169/46; 169/30

(57) ABSTRACT

Aqueous droplets encapsulated in a flame retardant polymer are useful in suppressing combustion. Upon exposure to a flame, the encapsulated aqueous droplets rupture and vaporize, removing heat and displacing oxygen to retard the combustion process. A polymer encapsulant, through decomposition, may further add free radicals to the combustion atmosphere, thereby further retarding the combustion process. The encapsulated aqueous droplets may be used as a replacement to halon, water mist, and dry powder flame suppression systems. In one embodiment of the invention, the aqueous droplets include a gelling agent, such as sodium alginate, and are encapsulated in an alginate-based material.

### CROSS-REFERENCE TO RELATED APPLICATIONS

This is a continuation-in-part application of pending U.S. application Ser. No. 10/476,175, filed Nov. 4, 2003, corresponding to PCT Application No. PCT/US02/16009, filed May 20, 2002, which is based on Provisional Application No. 60/293,918, filed May 25, 2001, the contents of which are fully incorporated herein by reference.

### STATEMENT OF GOVERNMENT INTEREST

The invention described herein was made by an employee of the United States Government and may be manufactured and used by or for the Government of the United States of America for governmental purposes without the payment of any royalties thereon or therefor.

### FIELD OF THE INVENTION

The present invention is directed to a non-toxic fire extinguishing, or flame suppression, agent.

### BACKGROUND OF THE INVENTION

It is well known that water effectively suppresses or “puts out” a flame by lowering the flame temperature and reducing the concentration of oxygen available for the combustion process. For example, water mists have met with recent success as a fire suppression agent. The temperature of the flame is lowered because the high latent heat of vaporization of water absorbs energy from the flame as the water evaporates. The concentration of oxygen is lowered because the water droplets actually displace oxygen as they evaporate.

One of the drawbacks of employing water mists is the difficulty in producing such mists in confined areas and the fact that water can evaporate before it reaches the base of the flame. Halons have been used to overcome these types of problems: however, they contribute to global warming and ozone depletion. Furthermore, production of halons is currently banned by international agreement. Conventional halon replacements have been found to be ineffective and/or may contribute to global warming or ozone depletion.

There is a current need for a water droplet system that can effectively deliver water droplets to the flame, extract sufficient energy from the flame by evaporation of the water droplets, displace oxygen with the vaporized water, and inhibit the flame propagation reaction.

When halon production was barred in the early 90's due to its strong contribution to ozone depletion and global warming, an intensified effort began to find suitable replacement agents. Because the agent should be adaptable for indoor use, it was necessary to find non-toxic agents. In addition, because of the need to suppress fires that may endanger and even engulf electronic components, it was necessary for the agent to be gaseous or liquid with low residue.

After considering a variety of materials, small particle water mist (from 10-100μ in size) was found to meet many of the requirements of a successful flame suppression agent. For example, advantages to the chemical nature of water include the following:

1. Evaporation of water produces water vapor that acts as an inert gas to reduce the concentration of oxygen.

2. Water is non-toxic.

3. Water does not contribute to ozone depletion.

4. Vaporization of water is very endothermic due to the large enthalpy of vaporization, which lowers the flame temperature.

5. Water does not contribute to global warming.

However, water droplets have several problems that must be overcome before they can be utilized in flame suppression. These problems include:

1. Water freezes below 0° C.

2. Distribution of small size water droplets is difficult.

3. Production of monodispersed droplets is very difficult.

4. Projection of water mist into a fire is difficult.

5. A large portion of the water droplets evaporate before they reach the flame.

As will become clear from the following, the present invention provides a way of realizing the benefits from using small size water droplets, or water-containing droplets, to retard and suppress a flame while, at the same time, overcoming the known problems associated with the use of such water droplets.

### SUMMARY OF THE INVENTION

Non-toxic flame suppression agents including encapsulated aqueous droplets are useful in suppressing combustion. Upon exposure to a flame or excessive heat, the encapsulated aqueous droplets rupture and vaporize, removing heat and displacing oxygen to retard the combustion process. In one embodiment, an aqueous droplet is encapsulated by a non-toxic flame retardant polymer which, through decomposition, may further add free radicals to the combustion atmosphere, thereby further retarding the combustion process. In another embodiment, an alginate-based material is used to encapsulate an aqueous droplet including water and a gelling agent. The encapsulated aqueous droplets may be used as a replacement to halon, water mist, and dry powder flame suppression systems.

The present invention is directed to a non-toxic flame suppression agent including encapsulated aqueous droplets. In one embodiment, the non-toxic flame suppression agent includes aqueous droplets encapsulated in a non-toxic flame retardant polymer. In another embodiment, the non-toxic flame suppression agent includes an aqueous droplet including water and a gelling agent encapsulated by an alginate-based material. For another embodiment, the invention provides a method of suppressing a flame using the non-toxic flame suppression agent. The method includes applying the non-toxic flame suppression agent including encapsulated aqueous droplets to the flame. For yet another embodiment, the invention provides a flame suppression system. The flame suppression system includes a container containing the non-toxic flame suppression agent including encapsulated aqueous droplets and a dispenser for dispensing the non-toxic flame suppression agent including encapsulated aqueous droplets from the container upon demand. The invention further includes methods and apparatus of varying scope.

### BRIEF DESCRIPTION OF THE DRAWINGS

The features and advantages of the present invention will become apparent from the following detailed description of a preferred embodiment thereof, taken in conjunction with the accompanying drawings, in which:

FIGS. 1A-1C are representations of process stages in the encapsulation of aqueous droplets by an in-liquid drying, or complex emulsion, technique for use with embodiments of the invention.

FIG. 2 is a flowchart of the encapsulation of aqueous droplets by a selective polymer solubility technique for use with embodiments of the invention.

FIG. 3 is a flowchart of an interfacial polymerization encapsulation technique for encapsulation of aqueous droplets for use with embodiments of the invention.

FIG. 4 is a simplified schematic of a fire suppression system in accordance with an embodiment of the invention.

### DETAILED DESCRIPTION OF PREFERRED EMBODIMENTS

The following embodiments of the present invention are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims and equivalents thereof.

The present invention is directed to a non-toxic flame suppression agent including an aqueous droplet containing water encapsulated in a non-toxic material. Preferably, the flame suppression agent has a size of approximately 5-250 microns. The flame suppression agent is applied to a flame and ruptures upon contact with the flame to release water from the aqueous droplet in the form of water vapor. In one embodiment, the aqueous droplet is encapsulated in a non-toxic flame retardant polymer. In another embodiment, the aqueous droplet includes water and a gelling agent encapsulated in an alginate-based material. Microencapsulation serves to stabilize the aqueous droplets and prevent their premature evaporation. For embodiments using a halogenated polymer for encapsulation, decomposition of the encapsulated aqueous droplets will give rise to free radicals, which function to further inhibit flame propagation. The non-toxic flame suppression agent can be used to replace current agents in halon, water mist, and dry powder fire extinguishers.

The commercial application of microencapsulation techniques began in 1940 with the development for the first carbonless copy paper by Barrett Green (American Chemical Society Symposium on Microencapsulation: Processes and Applications, held in Chicago, August 1973, Jan E. Vandegaer, Ed., Plenum Press, NY and London, p 3.) and by 1959 with the development of new methods and commercial applications the field began an explosive growth. Microencapsulation techniques are thus well known and many are suitable for the encapsulation of aqueous droplets. As one example, a review of microencapsulation methods by Thies (Microencapsulation, Kirk-Othmer, Encyclopedia of Chemical Technology, pp 628-651, Vol. 16, 4.sup.th Ed, John Wiley & Sons, New York) finds several techniques that are suitable for use with the invention:

1. Complex coacervation

2. Polymer-Polymer incompatibility

3. Interfacial polymerization at liquid-liquid interfaces

4. In situ polymerization

5. Solvent evaporation or in-liquid drying

6. Selective polymer solubility

7. Submerged nozzle extrusion

8. Spray drying

9. Fluidized bed

10. Centrifugal extrusion

11. Extrusion or spraying into a desolvation bath

12. Rotational suspension separation

Alginate-based microencapsulation techniques have been widely used in the medical field to provide for the time-release of pharmaceuticals for in vivo application. For example, T. Maguire, reported in Biotechnology and Bioengineering, “Alginate-PPL Microencapsulation: Effect on the Differentiation of Embryonic Stem Cells in Hepatocytes,” Vol. 93, No. 3, Feb. 20, 2006, a method that produced a water insoluble calcium alginate microcapsule wall. Alginic acid is extracted from seaweed as the sodium salt and finds many large commercial applications in the food industry. Such microencapsulation techniques may be similarly used to form the non-toxic flame suppression agent as provided herein. In this embodiment, the non-toxic flame suppression agent includes an aqueous droplet containing water and a gelling agent encapsulated by an alginate-base material. For example, an aqueous sodium alginate solution and an aqueous calcium chloride solution may be combined to form a microcapsule having the aqueous sodium alginate material encapsulated by a calcium alginate wall. This microcapsule, having the aqueous sodium alginate material encapsulated by a calcium alginate wall, may be used as the non-toxic flame suppression agent in accordance with one embodiment of the present invention. It should be understood that any water insoluble alginate salt would provide a suitable microencapsulating wall of alginate-based material. For example, other ions that form insoluble alginate material like barium alginate can be used wherein barium chloride is substituted for calcium chloride as provided in the above-mentioned embodiment. To further support the aqueous droplet, a polymer coating may be provided on the surface of the alginate-based material forming the microencapsulting wall. For example, the microcapsule having the aqueous sodium alginate material encapsulated by a calcium alginate may be provided with a polymer coating applied to the surface of the calcium alginate wall. In one embodiment of the invention, this polymer coating is provided as a non-toxic flame retardant polymer.

Several examples are provided herein for the manufacture of encapsulated aqueous droplets in accordance with the invention. However, the invention is not limited to a specific microencapsulation technique.

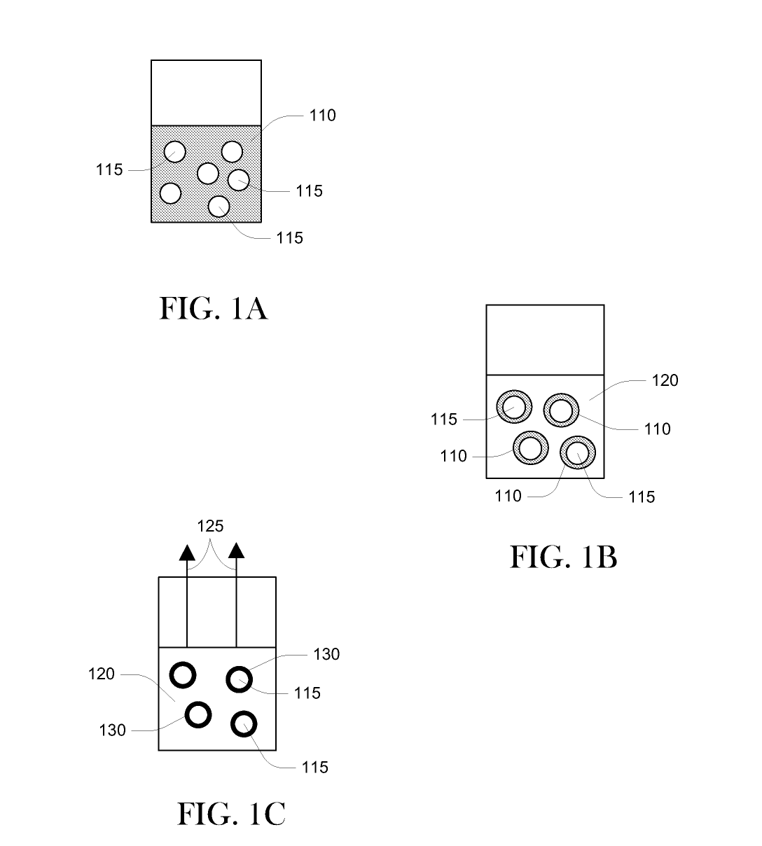

FIGS. 1A-1C are representations of process stages in the encapsulation of aqueous droplets by an in-liquid drying, or complex emulsion, technique for use with embodiments of the invention. In general, an aqueous phase 115 is dispersed in a hydrophobic organic phase 110 as shown in FIG. 1A to produce a water-in-oil emulsion. A high-speed blender or homogenizer can be used to create a water-in-oil emulsion.

For one embodiment, the aqueous phase 115 is essentially water. For another embodiment, the aqueous phase 115 contains a gelling agent in addition to water. For yet another embodiment, the aqueous phase 115 additionally contains a surfactant to aid in forming the droplets. The aqueous phase 115 may further contain additional components that do not materially affect the basic and novel properties of the flame suppression agents disclosed herein. The organic phase 110 contains the encapsulant in solution.

Encapsulants for use with the invention are non-toxic flame retardant polymers. Examples of some non-toxic flame retardant polymers include halogenated polymers and, more specifically, brominated polymers. For one embodiment, the brominated polymer is a bromostyrene polymer, such as poly(4-bromostyrene). However, other non-toxic polymers with flame retardant properties may be used. In general, the non-toxic flame retardant polymer should be self-extinguishing upon removal of a heat source. For one embodiment, the organic phase 110 contains poly(4-bromostyrene) dissolved in methylene chloride.

In FIG. 1B, a second aqueous phase 120 is added to the emulsion, thereby generating a (water-in-oil)-in-water emulsion. For one embodiment, the second aqueous phase 120 contains substantially the same composition as the first aqueous phase 115. For another embodiment, the second aqueous phase 120 contains water and a gelling agent having a concentration of the gelling agent of less than the first aqueous phase. Solvent 125 is then driven from the organic phase 110 to leave droplets of the aqueous phase 115 encapsulated in the non-toxic flame retardant polymer 130 as shown in FIG. 1C.

Additional detail on the foregoing encapsulation technique may be found in Microencapsulation Processing and Technology, Marcel Dekker, Inc., Pub., 1979, page 110, described by A. Kondo and J. W. van Valkenburg. The principle of this method is to disperse the core material, i.e., the aqueous phase, in a solution of wall-forming material, i.e., the hydrophobic solvent containing the non-toxic flame retardant polymer. The initial dispersion is then dispersed in an aqueous solution of a protective colloid (gelatin or similar material) followed by evaporation of the hydrophobic solvent. Once the solvent is evaporated, the encapsulated product may be isolated by filtration, washed with water to remove excess protective colloid, and air-dried.

For one embodiment, microencapsulation by selective polymer solubility is used to form the encapsulated aqueous droplets. Such encapsulation can be achieved by controlling the solubility of a polymer dissolved in a continuous phase of an emulsion. Solubility control is accomplished by adjusting the ratio of the two miscible hydrophobic solvents, one of which is a solvent for the polymer and one of which is not. In general, an aqueous phase is dispersed in a first hydrophobic solvent phase to produce a water-in-oil emulsion. The aqueous phase may contain a surfactant and/or gelling agent to aid in forming the desired droplets. The first hydrophobic solvent phase contains an encapsulant dissolved in a first hydrophobic solvent.

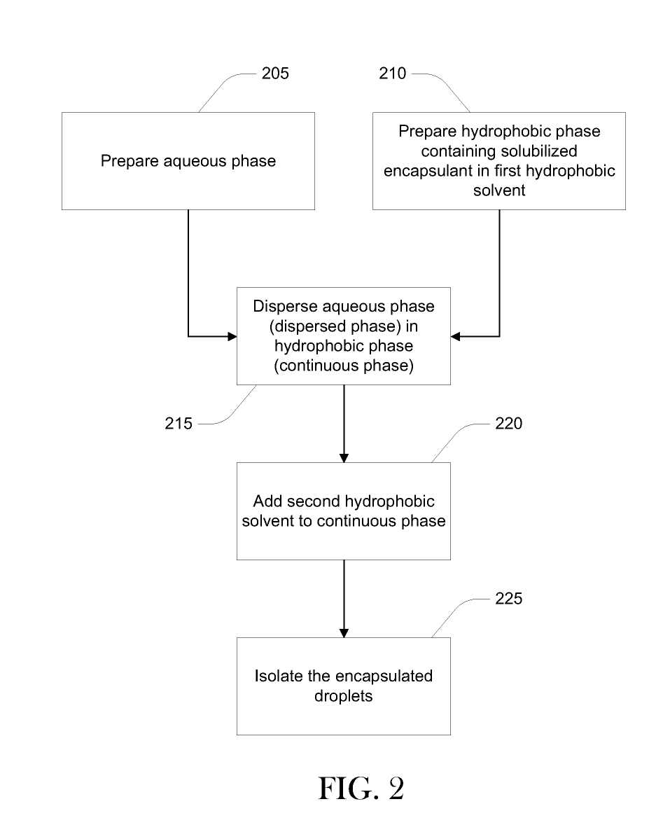

FIG. 2 is a flowchart of the encapsulation of aqueous droplets by a selective polymer solubility technique for use with embodiments of the invention. An aqueous phase and a hydrophobic phase are prepared at 205 and 210, respectively. The aqueous phase contains at least water. The aqueous phase may further contain at least one of a surfactant or a gelling agent. The hydrophobic phase contains the non-toxic flame retardant polymer encapsulant solubilized in a first hydrophobic solvent. As one example, the hydrophobic phase contains poly(4-bromostyrene) in methylene chloride.

At 215, the aqueous phase is dispersed in the hydrophobic phase to form an emulsion of the aqueous phase as the dispersed phase and the hydrophobic phase as the continuous phase. At 220, a second hydrophobic solvent is added slowly to the continuous phase. The first hydrophobic solvent is soluble, and preferably miscible, in the second hydrophobic solvent. Further, the non-toxic flame retardant polymer is substantially insoluble in the second hydrophobic solvent. This reduces the solubility of the flame retardant polymer in the first hydrophobic solvent, thus causing the polymer to deposit on the surface of the dispersed droplets of the aqueous phase. At 225, the encapsulated droplets are isolated or otherwise separated from the mixture. This can include a variety of separation techniques, including driving off the solvents through evaporation, filtering the encapsulated droplets from the mixture, centrifugal separation, etc.

For another embodiment, aqueous droplets are encapsulated using interfacial polymerization. Basically, microencapsulation by interfacial polymerization reactions occurs through condensation polymerization reactions, where some small molecule is eliminated in the process. For example, a polyester or polyamide can be prepared by reacting an acid chloride with an alcohol or an amine by eliminating an HCl molecule, see equations 1 and 2.

RCOCl+HOR′+RCOOR′+HCl Eq. 1

RCOCl+H₂NR′+RCONHR′+HCl Eq. 2

Condensation reactions in equations 1 or 2 take place between two different functional groups. For polymerization reactions, it requires that each monomer molecule unit have two functional groups. This means that either one monomer-molecule has the two different groups or two different molecules have two functional groups of the same type. Polymerization of each type of monomer system is illustrated in equations 3 and 4.

nH₂NRCOCl→H(NHRCO)ₙCl+(n−1)HCl Eq. 3

nClOCRCOCl+nH₂NR′NH₂→Cl(OCRCONHR′NH)ₙH+(n−1)HCl Eq. 4

There are generally four basic options for microencapsulation processes that use interfacial polymerization reactions to form the encapsulating shell. These options usually start by introducing a dispersed phase in the continuous phase by emulsification under agitation or by dispersing single droplets of the dispersed phase into the continuous phase with a nozzle or atomizer. The interfacial polymerization reaction then occurs using one of the following mechanisms:

1. Reaction illustrated by Equation 3 where the monomer is in the dispersed phase. In this manner, the shell material is deposited on the inner-side of the microcapsule.

2. Reaction illustrated by Equation 3 where the monomer is in the continuous phase. Here, the reaction occurs at the interface and deposits the polymer coating on the dispersed phase.

3. Reaction illustrated by Equation 4 where one monomer is in the dispersed phase and the other monomer is in the continuous phase. The polymerization reaction takes place at the interface.

4. Reaction illustrated by Equation 4 where both monomers are in the continuous phase. The polymer coating is deposited on the dispersed phase.

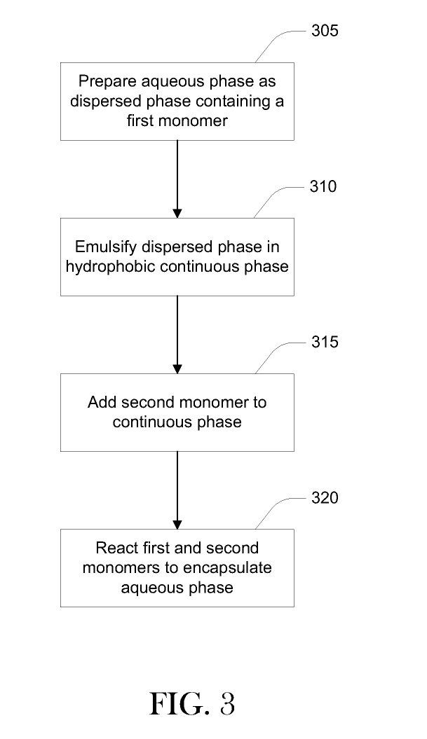

FIG. 3 is a flowchart of an interfacial polymerization encapsulation technique for encapsulation of aqueous droplets for use with embodiments of the invention. While the example of FIG. 3 is representative of an interfacial polymerization containing one monomer in the dispersed phase and one monomer in the continuous phase, other techniques of interfacial polymerization may be used in the formation of encapsulated aqueous droplets in accordance with the invention.

At 305, an aqueous phase is prepared as a dispersed phase containing a first monomer. The aqueous phase is then emulsified in a hydrophobic continuous phase at 310. A second monomer is added to the continuous phase at 315. The first and second monomers are then reacted at 320 to form the polymer encapsulant around the dispersed droplets of the aqueous phase.

In another embodiment, the non-toxic flame suppression agent is formed using alginates. A non-toxic flame suppression agent in the form of a microcapsule includes an aqueous droplet including water and a gelling agent encapsulated by an alginate-based material. Two fundamental concepts known to the chemical industry are applied to microencapsulation of an aqueous droplet including water and a gelling agent with an alginate-based material for making a non-toxic flame suppression agent. First, reactions at the interface between two immiscible fluids or materials that contain compounds capable of reacting to form coatings or polymers have been known for many years. Second, methods to produce microcapsules by creating a core material that is dispersed in a supporting fluid have been known for many years. When these two concepts are combined it is possible to produce a coating around the core material, which yields dry, free-flowing microcapsules. For the invention provided herein, the microcapsules that form the flame suppression agent are non-toxic and have the ability to extinguish a fire. Exchange reaction between counter ions of salts of organic acids change the solubility of the salt. For example, sodium and potassium salts tend to be water soluble, while divalent ions like barium or calcium tend to be water insoluble. For example, this method first creates an aqueous sodium alginate solution including water and sodium alginate, as the gelling agent, and a second aqueous calcium chloride solution. The aqueous sodium alginate solution may be dispersed as aqueous droplets that instantly exchange sodium ions for the calcium ions in the aqueous calcium chloride solution to produce a wall of water insoluble calcium alginate encapsulating the aqueous droplets. This ion exchange process is the basis for this embodiment of the invention which produces a non-toxic flame suppression agent in the form of microcapsules. Dispersions of aqueous droplets, which include water and a gelling agent such as sodium alginate, contain one component required to produce the wall of the microcapsules, for example sodium alginate, in a supporting fluid that contains the other component of the wall of the microcapsule, for example calcium chloride. These dispersions may be prepared to form microcapsules of a non-toxic flame suppression agent having aqueous droplets of water and a gelling agent encapsulated by an alginate-based material. A variety of techniques may be used to prepare the microcapsules in accordance with this embodiment of the invention, include drop-wise adding the aqueous sodium alginate solution to a solution of calcium chloride. Alternatively, an ultrasonic nozzle that provides a method for controlling the size of the microcapsules may be used to introduce the aqueous sodium alginate solution to a solution of calcium chloride. For example, the sodium alginate may be pumped through the nozzle that is submerged below the calcium chloride solution surface to produce the microcapsules. SONO-TEK® produces two types of nozzles that may be used in one embodiment of the present invention, the type described above and a nozzle that coats the sodium alginate droplet solutions as they exit with calcium alginate. The second type of nozzle generates encapsulated product directly from the nozzle.

The embodiment wherein the non-toxic flame suppression agent is formed by preparing a microcapsule having an aqueous droplet including water and a gelling agent encapsulated within an alginate-based material may be used for large-scale production of the non-toxic flame suppression agent. Methods similar to those used for time-released pharmaceutical production may be used to form the non-toxic flame suppression agents as provided in one embodiment of the present invention. Additionally, in one embodiment of the present invention, the aqueous droplet includes a sodium alginate solution containing at least 97 wt. % water. In addition, the sodium ions are components of some liquid fire extinguishing agents, which gives an added advantage for this extinguishing method. Other soluble salts, such as phosphates, could be added to further enhance the performance of the non-toxic flame suppression agent. Finally, the addition of a non-toxic flame retardant polymer coating, such as polystyrene and polybromostyrene, on the surface of the microcapsules could be used to enhance the storage life and flow characteristics of the non-toxic flame suppression agent. It is understood that a variety of commercial coating process could be used to coat the microcapsule.

Upon isolation of the encapsulated aqueous droplets, the encapsulated droplets may be used in a variety of flame suppression systems or may be otherwise applied to a flame for suppression. For example, in a typical dry powder fire extinguisher or suppression system, the encapsulated aqueous droplets can be used as the dry powder. By applying the encapsulated aqueous droplets to a flame, the vaporization of the contained water and other mechanisms described above can be used to suppress the flame.

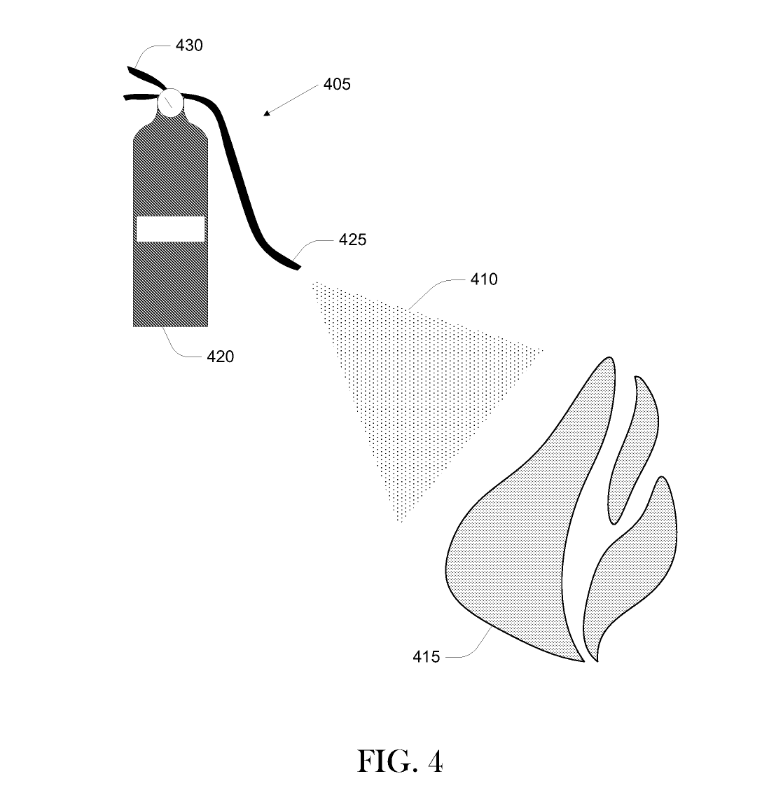

FIG. 4 is a simplified schematic of a fire suppression system 405 in accordance with an embodiment of the invention. The fire suppression system 405 is depicted as a typical hand-held dry powder fire extinguisher. However, other portable and fixed fire suppression systems may be used containing the non-toxic flame suppression agent including the encapsulated aqueous droplets 410 in accordance with embodiments the invention. The non-toxic flame suppression agent including the encapsulated aqueous droplets 410 are applied to a flame 415 to extinguish, or at least suppress, the flame 415. In general, the fire suppression system 405 is a system capable of storing the non-toxic flame suppression agent including the encapsulated droplets 410 and then dispensing the non-toxic flame suppression agent including the encapsulated droplets 410 upon demand. For example, the system 405 includes a pressurized cylinder 420 or other container for storing the non-toxic flame suppression agent including the encapsulated droplets 410. The system 405 further includes a dispenser for dispensing the non-toxic flame suppression agent including the encapsulated droplets 410. For the example shown in FIG. 4, the dispenser, collectively includes the nozzle 425 and valve mechanism 430. Upon activation of the valve mechanism 430, the non-toxic flame suppression agent including the encapsulated droplets can be dispensed from the pressurized cylinder 420 through the nozzle 425. Other dispensing mechanisms are well known, including pneumatic dispensers, pump dispensers, centrifugal dispensers, dump dispensers, etc.

The following non-limiting examples set forth below illustrate specific examples of the manufacture of non-toxic flame suppression agents in accordance with embodiments of the invention.

### EXAMPLE 1

### Microencapsulation of Water in Poly(4-bromostyrene) by In-Liquid Drying

In this example, poly(4-bromostyrene), the encapsulating polymer, was dissolved in methylene chloride, and food-grade unflavored gelatin was used to gel water and to serve as the protective colloid. A solution of 1.023 g of poly(4-bromostyrene) dissolved in 10 mL of methylene chloride was used as the continuous organic phase. A second solution, which was used as the dispersed phase, contained 0.412 g of gelatin dissolved in 9.607 g of deionized (DI) water. These solutions were mixed in a 39 mL flat bottom culture tube at 10,000 rpm with a Fisher model 700 Homogenizer with a saw-tooth generator (10 mm×195 mm) for 30 seconds. The resulting emulsion was poured into a 502 g solution of DI water that contained 5.007 g of food-grade unflavored gelatin that was agitated at approximately 2100 rpm with the model 700 Homogenizer with a flat bottom generator (35 mm×195 mm). The solution was agitated for 5 minutes at ambient temperature, and then the temperature was increased to 40° C. and held there until the methylene chloride had evaporated (approximately 1 hr). Filtering the mixture through a 2.7-micron glass-microfiber filter isolated the resulting microencapsulated water/gel. The crude product was washed 3 times with 200 mL of DI water, 1 time with 100 mL of a 0.1% gelatin solution, and 1 time with 100 mL of a 50:50 (vol:vol) solution of isopropyl alcohol (IPA). This process produced 0.639 g of microencapsulated particles in the 5 to 40 micron size range. When the speed of the generator for the second stage was decreased from approximately 2100 rpm to approximately 1400 rpm, the size of the final encapsulated material increased from the range of about 5 to 40 microns, to the range of about 60 to 70 microns; however, some of the material was as large as 250 micron. In addition, the yield of the microencapsulated particles increased when the DI water used in second stage and subsequent washing was saturated with methylene chloride. The bromine content in the polymer/gelatin residue, measured by SEM/EDS was the same as the polymer, poly(4-bromostyrene), 44%, implying that the gelatin content in the final product was low. The amount of water microencapsulated based on weight loss at 105° C. was approximately 21%.

### EXAMPLE 2

### Microencapsulation of Water with Poly(4-bromostyrene) by Selective Polymer Solubility

In this example, the solubility of a polymer is controlled by the ratio of two miscible solvents, e.g., hexane and methylene chloride. The fire retardant polymer, e.g., poly(4-bromostyrene), is soluble in the methylene chloride, but generally insoluble in the hexane. In a first stage, a solution of 0.28 g poly(4-bromostyrene) in 5.6 g methylene chloride was prepared. In a second stage, an aqueous gel was prepared by mixing 0.002 g of methyl cellulose and 0.001 g of sorbitan sesquioleate (an emulsifier) in 0.5 g of DI water. The aqueous gel was dispersed into the polymer solution prepared in the first stage using a homogenizer, e.g., a Fisher model 700. The speed was controlled to 1800 rpm to produce the desired particle size. 10 g of hexane was slowly added to the dispersion, thus lowering the solubility of poly(4-bromostyrene) in methylene chloride and causing the polymer to deposit on the surface of the dispersed droplets of aqueous phase. The resulting thickness of the encapsulating polymer is controlled by the ratio of polymer to dispersed aqueous phase. The final microencapsulated particles were in the 20 to 40 micron size.

### EXAMPLE 3

### Microencapsulation of Water with Poly(1,6-hexamethlylene tetrabromoterephthalate) by Interfacial Polymerization

In a first stage, an aqueous solution was prepared by dissolving 0.0073 g of 1,6-hexamethlyene diamine in 0.25 g water followed by the addition of 0.0029 g of sorbitan sesquioleate, 0.0041 g of sodium hydroxide, and 0.0013 g of methyl cellulose. In a second stage, a solution of 0.025 g of tetrabromoterephthaloyl chloride in 2.5 g of methylene chloride was prepared. 3.5 g of mineral spirits were added to a suitable mixing vessel followed by the addition of the aqueous solution prepared in the first stage. Next the solution prepared in the second stage was slowly added to the mixing vessel. This mixture was emulsified with a Fisher Model 700 Homogenizer at approximately 2800 rpm for 2 to 5 seconds. The desired speed is dependent upon the desired particle size, but, in general, increased agitation results in smaller particles. The reaction mixture was filtered through a 2.7-micron glass microfiber filter to isolate the microcapsules in the 5 to 20 micron size range. When toluene was substituted for mineral spirits and mixed in the same way, the isolated particles were in the 15 to 60 micron size range. A third variation on this process that used the same solutions prepared in the first and second stages, started by mixing 7 g of mineral spirits and the solution prepared in the second stage in a suitable mixing vessel. Then the solution prepared in the first stage was slowly added to the mixture in the mixing vessel through a fine capillary tube, which produced very small droplets of the first stage solution in the mineral spirit/second stage solution. These small droplets of the first stage solution were microencapsulated by the second stage solution to yield particles in the 10 to 50 micron size range.

EXAMPLE 4

### Microencapsulation of Water and Sodium Alginate with Calcium Alginate

First, 2.2 g of sodium alginate (Aldrich Chemical #180947) was dissolved in 100 mL of water and 1 mL of this solution was placed in a 2 mL syringe with a 22 gauge needle. Then, a second solution containing 2.2 g of calcium chloride (CaCl₂) dissolved in 200 mL of water was prepared. The CaCl₂ solution was stirred while small droplets of sodium alginate from the syringe were added. This procedure was repeated five times and the resulting solutions were allowed to stand for 10, 20, 40, 60, and 120 minutes at room temperature. The capsules settled to the bottom of the container and were harvested and examined under a microscope over several days with no indication of water loss. After about 1 month, the slides were reexamined and showed no change. An alternate method of dispersion was examined which used a small model paint sprayer to disperse the sodium alginate solution (2.2 g/101 g water) onto a pan that contained 2.2 g. CaCl₂in 201 g water. The pan was allowed to stand for 2 days and the capsules were harvested and washed with water. An additional 100 mL of water was added and the samples were let stand. Finally, the microcapsules were harvested and examined under a microscope. The large capsules were gel-like with irregular shape and the smaller capsules were spherical.

In order to improve the strength of the calcium alginate microcapsules, a microencapsulation method was employed to coat the calcium alginate microcapsules. This method applies a coating of a polymer, such as polystyrene, to particles, such as calcium alginate microcapsules. The procedure is as follows: (a) a 10 to 20-wt% solution of polystyrene in xylene is prepared, (b) the alginate microcapsules are added to a stirred polystyrene solution, (c) hexane, a non-solvent for polystyrene is slowly added, which causes the polystyrene to come out of solution and coat the microcapsules, (d) the coated capsules are removed from the solution by filtration, and (e) the microcapsules are washed with hexane and dried to give the final product.

### CONCLUSION

Aqueous droplets encapsulated in a flame retardant polymer and/or an alginate-based material have been described for use in suppressing combustion. Upon exposure to a flame, the encapsulated aqueous droplets rupture and vaporize, removing heat and displacing oxygen to retard the combustion process. The polymer encapsulant, through decomposition, may further add free radicals to the combustion atmosphere, thereby further retarding the combustion process. The encapsulated aqueous droplets may be used as a replacement to halon, water mist, and dry powder flame suppression systems.

We claim:

1. A method of suppressing a flame comprising:
applying to the flame a flame suppression agent including an aqueous droplet containing water encapsulated in a non-toxic material, wherein said flame suppression agent is non-toxic and has a size of approximately 5-250 microns, and
rupturing said flame suppression agent using said flame to release water from the aqueous droplet in the form of water vapor.

2. The method of claim 1, wherein said aqueous droplet contains water and a gelling agent and said non-toxic material is an alginate-based material.

3. The method of claim 2, wherein said gelling agent is sodium alginate.

4. The method of claim 2, wherein said alginate-based material is calcium alginate.

5. The method of claim 2, wherein said aqueous droplet is further coated with a non-toxic flame retardant polymer.

6. The method of claim 5, further comprising decomposing said non-toxic flame retardant polymer using the flame to release free radicals.

7. The method of claim 5, wherein said non-toxic flame retardant polymer is polystyrene or a halogenated polymer.

8. The method of claim 7, wherein the halogenated polymer is poly(4-bromostyrene) or poly(1,6-hexamethylene tetrabromoterephthalamide).

9. The method of claim 1, wherein said aqueous droplet consists of water and a food-grade gelatin encapsulated in a non-toxic flame retardant polymer consisting of poly(4-bromostryene) capable of decomposing upon exposure to heat from the flame to release free radicals for suppressing the flame.

10. The method of claim 1, wherein said step of applying to the flame a flame suppression agent includes applying to the flame a flame suppression agent provided as a small particle water mist.

11. A fire suppression system, comprising:
a container containing a flame suppression agent including an aqueous droplet containing water encapsulated in a non-toxic material, wherein said flame suppression agent is non-toxic and has a size of approximately 5-250 microns; and
a dispenser for dispensing the flame suppression agent from the container upon demand.

12. The fire suppression system of claim 11, wherein said aqueous droplet contains water and a gelling agent and said non-toxic material is an alginate-based material.

13. The fire suppression system of claim 12, wherein said gelling agent is sodium alginate.

14. The fire suppression system of claim 12, wherein said alginate-based material is calcium alginate.

15. The fire suppression system of claim 12, wherein said aqueous droplet is further coated with a non-toxic flame retardant polymer.

16. The fire suppression system of claim 15, wherein said non-toxic flame retardant polymer is polystyrene or a halogenated polymer.

17. The fire suppression system of claim 16, wherein the halogenated polymer is poly(4-bromostyrene) or poly(1,6-hexamethylene tetrabromoterephthalamide).

18. The fire suppression system of claim 11, wherein said aqueous droplet consists of water and a food-grade gelatin encapsulated in a non-toxic flame retardant polymer consisting of poly(4-bromostryene) capable of decomposing upon exposure to heat from the flame to release free radicals for suppressing the flame.

19. The fire suppression system of claim 11, wherein said fire suppression system is a dry powder suppression system.

20. The fire suppression system of claim 11, wherein said fire suppression system is a water mist suppression system.
